(19) United States
(12) Patent Application Publication
(10) Pub. No.: US 2025/0262944 A1
(43) Pub. Date: Aug. 21, 2025

(54) Vehicle High Voltage Electronics Box

(71) Applicant: Vitesco Technologies USA, LLC, Auburn Hills, MI (US)

(72) Inventors: Yicheng Wang, Windsor (ON); Aniket Anand, Windsor (ON); Philip Georg Brockerhoff, Regensburg (DE); Ayman Ayad, Regensburg (DE)

(73) Assignee: Vitesco Technologies USA, LLC, Auburn Hills, MI (US)

(21) Appl. No.: 19/189,691

(22) Filed: Apr. 25, 2025

Related U.S. Application Data
(63) Continuation of application No. PCT/US2023/077995, filed on Oct. 27, 2023.

(30) Foreign Application Priority Data
Oct. 27, 2022 (US) 63381263

(51) Int. Cl. B60L 15/00; H02M 1/42; H02M 3/335

(52) U.S. Cl. CPC B60L 15/007; H02M 1/4216; H02M 3/33584; B60L 2240/547; B60L 2240/549; B60L 2260/40

(57) ABSTRACT

The disclosure provides a method of operating a system supported by an electric vehicle (EV). The method includes receiving input data from the input. When the input data is indicative of the EV being in a driving status, the method includes executing a first mode of operation causing a high voltage battery supported by the EV to supply power to one or more low voltage loads and to a motor. When the input data is indicative of the EV being connected to an alternating voltage source, the method includes executing a second mode of operation causing the motor and an inverter to behave as a two-phased interleaved PFC circuit. When the input data is indicative of the EV being connected to a direct voltage source, the method includes executing a third mode of operation causing the motor and the inverter to behave as a two-phased interleaved boost converter circuit.

### TECHNICAL FIELD

The disclosure relates to a vehicle electronics box that functionally and electrically integrates several electrical power electronics.

### BACKGROUND

An electric car, an electric vehicle (EV), or a battery electric vehicle are all used to describe automobiles powered by one or more electric motors using energy stored in one or more rechargeable energy storage units such as batteries or other electricity storage devices such as supercapacitors. Electric vehicles (EV) have one or more complex networks of power electronics where each includes converters, inverters, and control systems. Each complex network of power electronics converts and manages electrical energy to drive the vehicle, charge the vehicle battery, and ensure overall system efficiency. To fulfill such functionalities, various power electronics subsystems, packaged individually, are found under the EV vehicle hood.

Current market projections anticipate a highly integrated power electronics system in the next generation of battery electric vehicles (BEV). Overall reduction in size, cost, and weight of power electronics converters, onboard chargers (OBC), traction inverters, and auxiliary power modules (APM) are some of the key factors to achieve the highly integrated system. The transition from low-switching frequency converters to high-switching frequency converters has drastically reduced the size and cost of the magnetics in the system. Moreover, the hybrid solution with combinations of different wide band gap devices like SiC and GaN at different stages of power conversion offers further cost savings and efficiency improvement.

Some of the known solutions to the above-mentioned deficiencies are described in U.S. Patent Application Publication No. 20110221363A 1 which relates to a combined electric device for powering and charging and proposes a device for the open-end winding machine. The machine includes three H bridges and operates in two operating modes: powering mode in which two inverters are used to feed the alternating current to open end winding machine and charging mode when motor windings are used as an inductor to feed three-phase power from the grid to the battery.

Another solution is discussed in U.S. Patent Application Publication No. 20190126763A 1 which relates to a combined electric device for powering and charging. This application claims a charging system utilizing a six-phase machine with two sets of galvanically isolated windings. A vehicle includes two inverters and three-phase inductors. In this case, isolation is provided between battery and charge port in the proposed charging system using six-phase machine.

Another solution is discussed in U.S. Patent Application Publication No. 20170305283A 1 which relates to an integrated charger for vehicles. This application provides a traction system with an additional inductor in series with motor winding to realize a DC-DC converter. Two additional inductors with two-phase windings are realized as a DC-DC converter. Buck-boost DC-DC converter is formed using additional inductors and motor winding for charging.

Yet another solution is discussed in U.S. Patent Application Publication No. 20130307333A 1 which relates to an inverter-charger combined device for electric vehicles. This application provides a system with an additional single-phase rectifier and buck converter. An inverter charger combined device utilizes the three-phase motor windings. The device claims the functionality of high voltage charger, low voltage charger, and inverter operation.

The known described systems discuss a traditional battery electric vehicle system which includes independent power electronics conversion systems that includes the traction inverter for driving the electric machine, an OBC for charging the high voltage (HV) battery from the AC grid, a DC boost charger for charging the HV battery from the legacy 400 V DC charger, and an APM for feeding different auxiliary loads. Therefore, there is a need for a system that functionally and electrically integrates several independent power conversion systems into one box.

### SUMMARY

One aspect of the disclosure provides a method of operating a system based on an input to the system. The method includes receiving input data from the input. When the input data is indicative of the EV being in a driving status, the method includes executing a first mode of operation causing a high voltage battery supported by the EV to supply power to one or more low voltage loads and to supply power to a motor of the EV. When the input data is indicative of the EV being connected to an alternating voltage source, the method includes executing a second mode of operation causing the motor and an inverter supported by the EV to behave as a two-phased interleaved PFC circuit to convert alternating voltage or power from the alternating voltage source to direct power. When the input is indicative of the EV being connected to a direct voltage source (e.g., 400 V DC), the method includes executing a third mode of operation causing the motor and the inverter to behave as a two-phased interleaved boost converter circuit to boost the direct voltage or power.

Implementations of the disclosure may include one or more of the following optional features. In some implementations, the first, second, and third modes of operation are mutually exclusive. The input data includes at least one of a voltage sensor data, a current sensor data, and vehicle motion sensor data.

In some examples, the two-phased interleaved boost converter circuit includes a first two-phased interleaved boost converter circuit and a second two-phased interleaved boost converter circuit. The two-phased interleaved PFC circuit may include a first two-phased interleaved PFC circuit and a second two-phased interleaved PFC circuit. The first mode of operation causes the high voltage battery to supply power to an additional motor of the EV.

Another aspect of the disclosure provides a system operating in three modes of operation. The system includes data processing hardware. The system also includes memory hardware in communication with the data processing hardware. The memory hardware stores instructions that when executed on the data processing hardware cause the data processing hardware to perform operations that include the method described above.

Yet another aspect of the disclosure provides a system operating in three modes. The system includes an input that receives input data from one or more sensors. The system includes a traction motor. The system also includes an inverter connected to the traction motor. The system also includes a DC-link capacitor connected to the inverter. Additionally, the system includes a high voltage battery and a low voltage load. The system also includes an isolated DC-DC triple active bridge having three bridges, a first bridge connected to the DC-link capacitor, a second bridge connected to the low voltage load, and a third bridge connected to the high voltage battery.

Implementations of this aspect of the disclosure may include one or more of the following optional features. In some implementations, when the input data is indicative of the EV being in a driving status, the high voltage battery supplies power to the low voltage load and to the traction motor. In some examples, when the input data is indicative of the EV connected to an alternating current, the traction motor and the inverter behave as a two-phased interleaved PFC circuit to convert alternating power to direct power. Additionally, in some examples, when the input data is indicative of the EV connected to a direct voltage source such as a 400 V DC, the traction motor and the inverter behave as a two-phased interleaved boost converter circuit to boost the direct power of the direct voltage source.

In some implementations, the traction motor includes a first traction motor and a second traction motor; the inverter includes a first inverter and a second inverter; the DC-link capacitor includes a first DC-link capacitor and a second DC-link capacitors; and the isolated DC-DC TAB includes a first isolated dc-dc tab and a second isolated DC-DC TAB. The one or more sensors include voltage sensor, current sensors, and vehicle motion sensor.

### DESCRIPTION OF DRAWINGS

FIG. 1A is a schematic view of an exemplary system supported by an electric vehicle.

FIG. 1B is a schematic view of a circuit of the system of FIG. 1A.

FIG. 2A is a schematic view of the circuit shown in FIG. 1B during a first mode of operation.

FIG. 2B is a block diagram of the first mode of operation of the circuit shown in FIG. 2A.

FIG. 3A is a schematic view of the circuit shown in FIG. 1B during a second mode of operation.

FIG. 3B is a block diagram of the second mode of operation of the circuit shown in FIG. 3A.

FIG. 4A is a schematic view of the circuit shown in FIG. 1B during a third mode of operation.

FIG. 4B is a block diagram of the third mode of operation of the circuit shown in FIG. 4A.

FIG. 5 is a schematic view of an exemplary arrangement of operations for a method of operating the system of FIGS. 1A-4B based on a first, second, and third mode of operations.

Like reference symbols in the various drawings indicate like elements.

### DETAILED DESCRIPTION

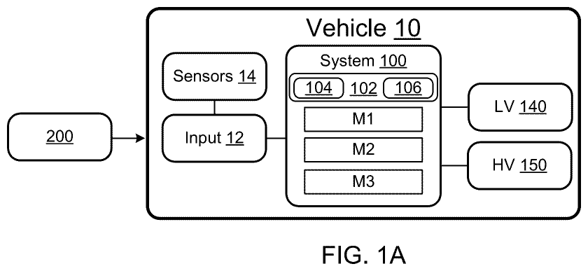

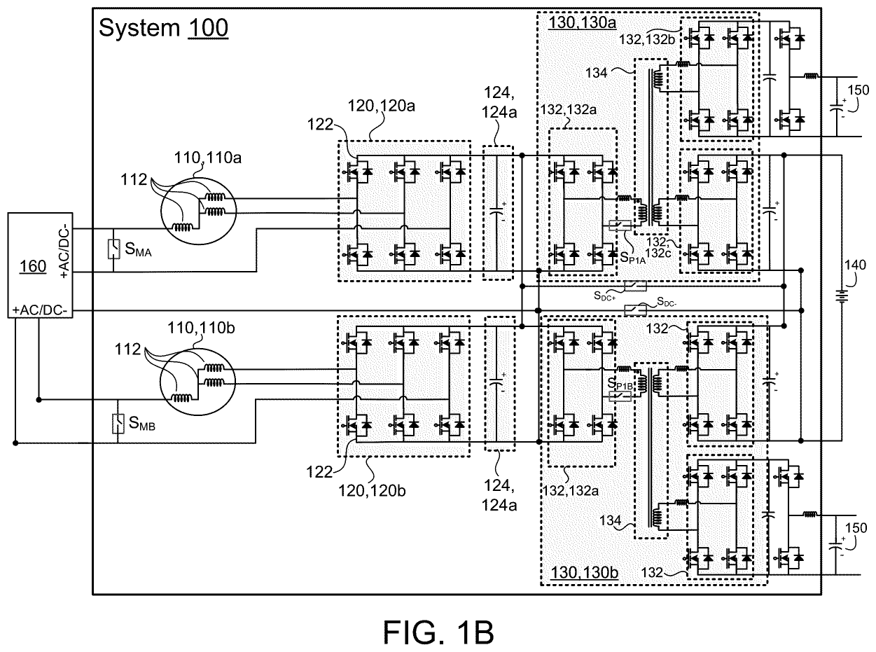

The disclosure provides a single highly integrated system 100 supported by a vehicle 10 shown in FIGS. 1A and 1B. In some examples, the system 100 is a high voltage electronics box that functionally and electrically integrates several sub-systems of the vehicle 10. The system 100 includes independent power conversion sub-systems each supporting several electronics of a battery electric vehicle (BEV) 10. The system 100 supports an 800 Volt vehicle architecture, dual motor drives, single/split phase A C charging, DC boost charging, and LV (low voltage) DC/DC. In other words, the system 100 includes several power electronics conversion sub-systems that are part of the system 100, i.e., the HV electronics box, resulting in reduced size, cost, and weight of power electronics converters in the BEV 10 by having a single integrated system 100.

The system 100 integrates the following high voltage power electronics: traction inverter, on-board charger (OBC), DC boost charger, and high voltage to low voltage (LV) DC/DC converter. The traction inverter is essential to the system 100 since it converts a direct current (DC) supply from the vehicle's batteries into an alternating current (AC) output. The OBC, e.g., including AC charging circuits, converts AC power from external sources, such as residential outlets, to DC power that is used to charge the vehicle's battery pack. The DC Boost Charger converter steps up the voltage while stepping down the current from its input (supply) to its output (load). For example, the DC boost charger can boost the voltage from 400V to 800V. In addition, the LV DC/DC converter provides power flow from a high voltage, such as 800V, to low voltage such as 12V. The benefits of the system 100 includes having the OBC and traction inverter within one package; Bidirectional AC & DC Boost charging utilizing inverter power module and motor winding; and significant device volume and cost reduction; and following the automotive industry high integration trend. Additionally, the system 100 utilizes motor winding of a traction motor for AC and DC boost charging, without any modification to the conventional Y connected three phase motor. The system 100 provides Dual bank configuration for AC and DC boost charging for scalable charging power.

The system 100 includes several levels of integration. A first level of integration includes a traction inverter and a PFC converter where all of the inverter switches are reused to realize a single/split phase PFC converter for charging. Secondly, for the DC boost charging from 400 V DC source to 800 V DC, the same inverter switches are used to achieve an interleaved DC boost converter operating in continuous conduction mode. Thirdly, the magnetic integration where both HV DC-DC and low voltage (LV) DC-DC isolation is provided by a single three-port transformer. Lastly, motor windings are utilized as the PFC coil and the boost inductor, thus, further reducing the magnetic requirement. As such, the system 100 provides a significant volume and cost reduction.

The system 100 includes a controller 102 having a computing device (or processor) 104 (e.g., central processing unit having one or more computing processors) in communication with non-transitory memory 106 (e.g., a hard disk, flash memory, random-access memory) capable of storing instructions executable on the computing processor(s) 104. In some examples, the controller 102 executes a method for determining a mode of operation M 1, M 2, M 3 of the system 100 based on one or more inputs 12. In some examples, the input 12 includes sensor data from one or more sensors 14 indicative of the vehicle motion, i.e., speed, angular speed, position, etc. The sensors 14 may include an inertial measurement unit (IMU) configured to measure the vehicle's linear acceleration (using one or more accelerometers) and rotational rate (using one or more gyroscopes). Additionally, the sensors 14 may include voltage and current sensors to determine if the vehicle 10 is being charged and the type of charging input (e.g., AC or DC).

The system 100 supports an 800V BEV architecture having at least two traction motors 110, 110a, 110b. A traction motor 110 is used to convert stored electrical energy (e.g., from the HV battery 140) to mechanical energy causing the vehicle 10 to move. In some examples, the traction motors 110 require AC power to operate, as such a traction inverter 120 is used to convert the DC power from the battery source i.e., HV battery 140, into a three-phase AC power. In some examples, the two motors 110 are a front traction motor 110a, and a rear traction motor 110b of a dual-motor BEV or two rear motors of a quad-motor and tri-motor BEV. The two motors may have other configurations. about

The system 100 also includes two traction inverters 120, a first traction inverter 120a and a second traction inverter 120b. The traction inverter 120 is configured to convert a DC supply from the HV battery 140 into an AC current for the motors 110. In some examples, the traction inverters 120 are a front traction inverter and a rear traction inverter. In some examples, the inverter 120 is a 3-phase power module. Each traction inverter 120 includes six switches 122 configured to switch the voltage and current from high-voltage battery on and off to create the AC drive for the motor 110. In some examples, the switches are a MOSFET or IGBT. Each traction inverter 120 is electrically connected to a DC link capacitor 124. The DC link capacitor 124 is configured to smooth out and steady DC voltage to protect the traction inverter 120 by absorbing sudden voltage increases. In some examples, the first traction inverter 120a is connected to a first DC link capacitor bank 124a, and the second traction inverter 120b is connected to a second DC link capacitor bank 124b.

As shown, the system 100 includes two isolated DC-DC Triple active bridge (TAB) converters 130, 130a, 130b where each TAB 130, 130a, 130b includes three H-bridges 132 interlined using a three-port transformer 134, e.g., a three winding high frequency transformer (HFT). In some examples, a serial resonant converter or a combination of the TABs 130 and serial resonant converter may be used instead of the two TABs 130 shown. Each TAB 130 includes three ports. A first port is electrically connected to the DC-link 124 (Port 1), a second port is electrically connected to a high voltage battery 140 (Port 2), and a third port is connected to a low voltage load 150 (Port 3). The three ports are electrically isolated via the three-port transformer 134.

The system 100 also includes a high voltage (HV) battery 140, such as an 800V battery and one or more low voltage (LV) loads 150, 150a, 150b. The HV battery 140 is a rechargeable energy storage that supplies power to the traction motor 110 of the vehicle 10 when the HV battery 140 is charged. The HV battery 140 is charged by way of the grid connected to the vehicle during a charging state. The LV load 150 is used to power vehicle devices such as, but not limited to 12V Battery, battery disconnects, etc.

The system 100 also includes a first relay S_{DC+} and a second relay S_{DC-}. A relay is an electrically operated switch that commonly uses a coil to operate its internal switching mechanism. The relay includes a normally open (NO) terminal, a normally closed (NC) terminal, and a common terminal. In some examples, each DC link 124 may be electrically connected to the normally open (NO) terminal of each relay S_{DC+}, S_{DC-} which is in turn electrically connected to the HV battery 140. In this case, when the relay S_{DC+}, S_{DC-} is not powered, then the circuit to the HV battery 140 is open, while when the relay S_{DC+}, S_{DC-} is powered, then the circuit to the HV battery 140 is closed and power flows to the HV battery 140. In other examples, each DC link 124 may be electrically connected to the normally closed (NO) terminal of each relay S_{DC+}, S_{DC-} which is in turn electrically connected to the HV battery 140. In this case, when the relay S_{DC+}, S_{DC-} is powered, then the circuit to the HV battery 140 is open, while when the relay S_{DC+}, S_{DC-} is not powered, then the circuit to the HV battery 140 is closed and power flows to the HV battery 140. In some examples, switches may be used instead of the relays S_{DC+}, S_{DC-}.

Additionally, the system 100 includes a third Relay S_{P1A} and a fourth relay S_{P1B}. The third Relay S_{P1A} is electrically connected between the TAB primary H bridge 132a and the transformer 134 in the first TAB 130, 130a. The fourth relay S_{P1B} is electrically connected between the TAB primary H bridge 132a and transformer 134 in the second TAB 130, 130b. Relay S_{P1A} and S_{P1B} are closed during the AC charging mode to allow power flow from the DC link 124 to the HV battery 140 and the LV load 150; and remain open during the traction and DC boost charging mode. The system 100 also includes a fifth relay S_{MA} and a sixth relay S_{MB}. The fifth relay S_{MA} is electrically connected to one of the three phases in the motor 110, 110a, and the sixth relay S_{MB} is electrically connected to one of the three phases in the motor 110, 110b. Relay S_{MA} and S_{MB} are closed during the traction mode, to allow power flow from the inverters 120, 120a, 120b to the traction motor 110, 110a, 110b; and remain open during the AC and DC charging. The controller 102 controls the relays based on the inputs 12 causing the system 100 to adjust its behavior and function and execute one of the modes of operation M1, M2, M3.

The system 100 connects to a Power Distribution Unit (PDU) box 160, which has relays and busbars that connect to the vehicle charging connectors. The system 100 distributes the power from the charging station 200 to the vehicle 10 based on the charging mode (AC or DC).

### Modes of Operation

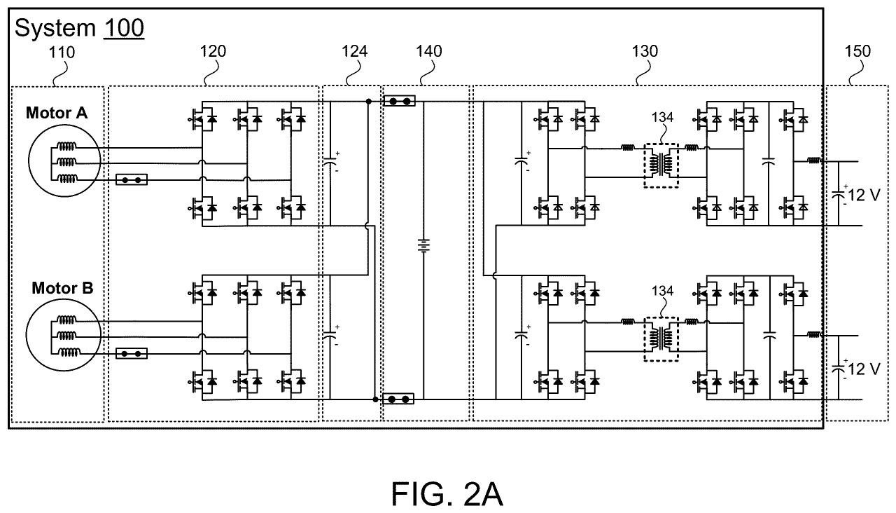

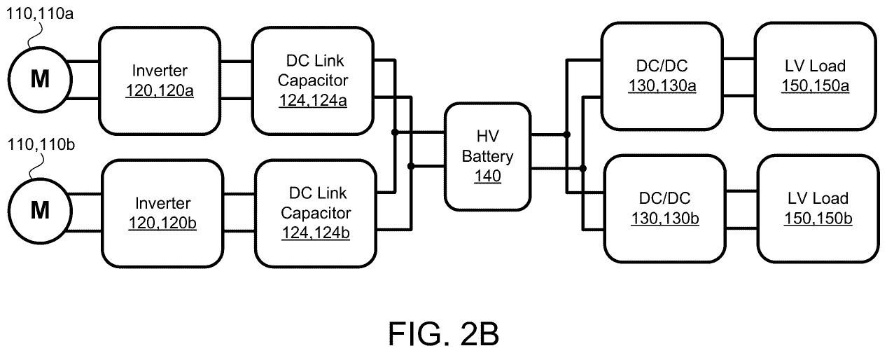

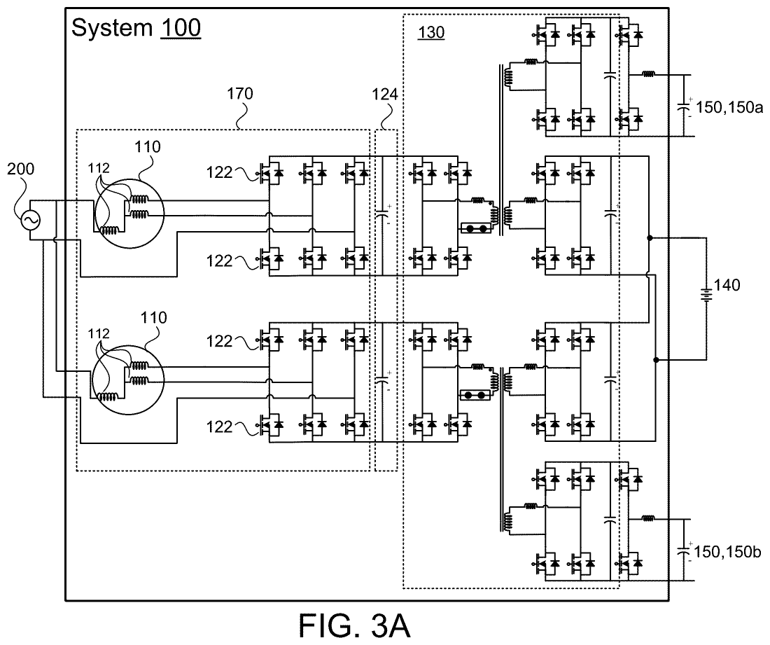

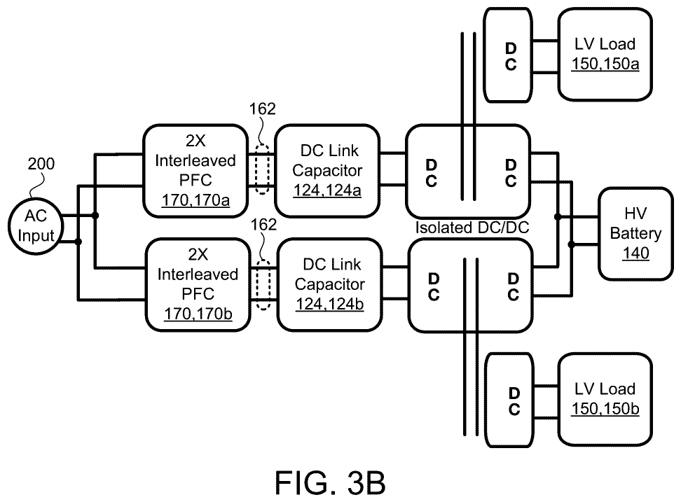

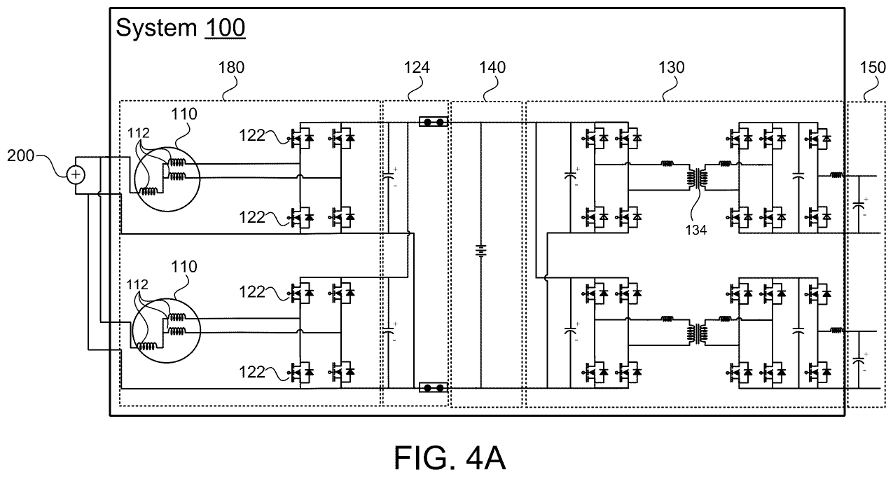

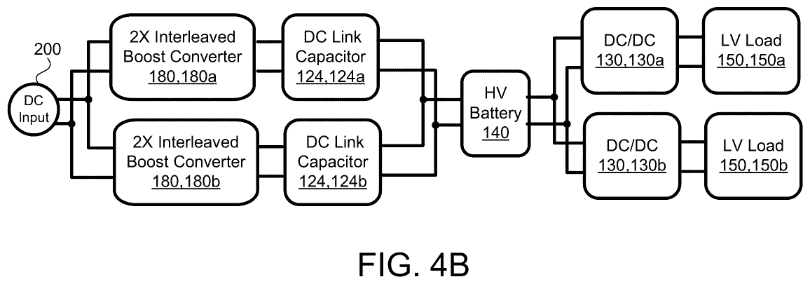

The system 100 is configured to operate under three mutually exclusive modes of operations: a first mode of operation M1 (FIGS. 2A and 2B), a second mode of operation M2 (FIGS. 3A and 3B), and a third mode of operation M3 (FIGS. 4A and 4B). The three modes of operation M1, M2, M3 of the system 100 are associated with four functionalities: (i) dual traction drives, (ii) single/split phase AC charging, (iii) auxiliary power module (APM) for converting the high voltage from the HV battery 140 down to the LV load 150, and (iv) DC boost charging.

### First Mode of Operation: Traction Mode

When the controller 102 detects that the input data from the input 12 is indicative of the vehicle 10 moving, i.e., driving condition, for example, from one or more sensors supported by the vehicle 10, then the controller 102 executes the first mode of operation M1. The first mode of operation M1 is only available and can only be executed when the vehicle 10 is in a driving condition. The first mode of operation is configured to utilize the HV battery 140 to charge and/or supply power to the LV load 150 and to supply power to the motor 110.

During the first mode of operation M1, the inverter 120 converts energy from the HV battery 140 to the motor 110. For example, the system 100 operates as a 2-level voltage source inverter which modulates the DC power from the HV battery 140 to A C power to drive the motors 110, 110a, 110b. In addition, during the first mode of operation M1 the HV battery 140 simultaneously charges the LV load 150, 150a, 150b through the dual active bridge converter formed by the port 2 and port 3 H-Bridges 132, 132b, 132c.

Referring to FIGS. 2A and 2B, during the traction mode M 1, the first and second relays S_{DC+}, S_{DC-} shown in FIG. 1A are closed to connect the HV battery 140 to the two DC links 124, 124a, 124b of the two parallel traction inverters 120, 120a, 120b. Each active bridge 132 of the TAB 130 galvanically connects the DC-link 124 (Port 1), HV battery 140 (Port 2), and LV load 150 (e.g., LV battery or load) (Port 3). Relays S_{P1A} and S_{P1B} from the top and bottom banks are disconnected during the traction mode (Mode 1) to disconnect the DC-link 124 (Port 1) of the TAB 130 for both parallel banks. The HV Battery 140 (Port 2) and the LV load 150 (Port 3) are galvanically connected through a dual active bridge (DAB) circuit 132b, 132c. This allows the power to flow from the HV battery 140 to charge the LV load 150 during the first mode of operation M1.

### Second Mode of Operation: AC Charging Mode

Referring to FIGS. 3A and 3B, when the controller 102 detects that the input data from the input 12 is indicative of the vehicle 10 being charged by an alternating voltage source 200, such as 240V_{AC} split phase/120V_{AC} single phase grid, then the controller 102 executes the second mode of operation M2. The second mode of operation M 2 is only available and can only be executed when the vehicle 10 is parked and being charged by a 240V_{AC} split phase/120V_{AC} single phase grid, i.e., the input 12 is 240V_{AC} split phase or 120V_{AC} single phase. During the second mode of operation M2 the motor 110 and the switches 122 of the inverters 120 operate as a dual bank Totem Pole interleaved Power Factor Correction (PFC) configuration 170. This eliminates the need for PFC coils, and PFC switches, utilizing the motor winding inductance 112 and traction inverter power module switches 122 to achieve significant power device reduction; Bi-directional power flow; and Dual bank configuration to fully utilize maximum charging power. In other words, the motor 110 and the inverter switches 122 behave as a dual bank Totem Pole interleaved PFC converter. As shown, relays S_{MA}, S_{MB}, S_{DC+}, and S_{DC-} are open, and relays S_{P1A}, S_{P1B} are closed.

During the second mode of operation M2, the motor 110 and the traction inverter switches 122 are utilized as a two-phase interleaved PFC (power factor correction) circuit 170. Each of the traction inverter 120 includes three single phase lags with six switches that behave as the two-phase interleaved Totem Pole PFC circuit. Two of the inverter phase legs operate as the PFC high frequency phase legs, which operates in high switching frequency; the third inverter phase leg operates as the PFC low frequency phase leg, which operates in the grid frequency (50/60Hz). The motor winding inductance 112 is utilized as the PFC boost coil. The PFC circuit 170 converts the AC grid voltage into DC voltage to charge the HV battery 140 and the LV load 150. In addition, the PFC circuit 170 also regulates the input power factor and current THD (Total Harmonic Distortion) to comply with the given standards. In some examples, each top and bottom bank of PFC can draw up to 9.6 kW from the grid simultaneously, and two parallel banks can draw up to 19.2 kW. The output 162 of each PFC circuit 170 is regulated at a constant DC voltage.

The integration of the OBC and APM (auxiliary power modules) utilizes the TAB converter 130 and three-port transformer 134. The TAB 130 transfers the DC bus power to charge the HV battery 140 and LV load 150 (e.g., step down voltage) simultaneously, and the three-port transformer 134 provides galvanic isolation between the AC input 12, HV battery 140, and LV load 150. The dual bank configuration provides redundancy, which is required by EV manufacturers. Furthermore, the TAB converter 130 also enables reverse power operation for vehicle-to-everything (V2X).

The voltage of the HV battery 140 at the third port P3 is determined by a battery state-of-charge (SOC) which represents the percentage of charge remaining in the HV battery 140 and may be determined by way of several methods. Several methods may be used, including, but not limited to the Coulomb Counting Method which is also referred to as the Ampere-Hour counting and current integration which relies on battery current readings mathematically integrated over a usage period to calculate the SOC value. In some examples, the voltage V of the HV battery 140 is measured by a voltage sensor.

In some examples, an input electromagnetic interference (EMI) filter (not shown) may be electrically connected between the 240V_{AC} split phase/120V_{AC} single phase AC grid input 12 and the motor 110. The EMI filter protects the electronics within the system 100 from damage caused by high levels of radiation emitted by other electronic equipment. Additionally or alternatively, in some examples, an output EMI filter (not shown) may be electrically connected between the LV load 150, i.e., third port of the TAB 132c, 130 and the HV battery 140 i.e., second port of the TAB 132c, 130.

### Third Mode of Operation: DC Charging in Boost Mode

Referring to FIGS. 4A and 4B, when the controller 102 detects that the input

data of the input 12 is indicative of the vehicle 10 being charged by a DC voltage source, such as a 400 V DC charging station 200, then the controller 102 executes the third mode of operation M3. The third mode of operation M3 is only available and can only be executed when the vehicle 10 is parked and being charged by a DC charging station 200, i.e., the input 12 is 400V DC. The DC boost charging functionality allows the 800 V battery 140 to be charged with a legacy 400 V DC fast charger. In this mode, relays S_{MA}, S_{MB}, S_{P1A}, and S_{P1B} are open, whereas S_{DC+}, S_{DC-} are closed as shown in FIGS. 4A and 4B.

During the third mode of operation M3, the motor 110 and two phase legs (four switches) 122 of each inverter 120 operate as a dual interleaved boost converter 180. Since a basic boost converter converts a DC voltage to a higher voltage, the behavior of the circuit as a dual interleaved boost converter 180 reduces the inductor ripple current which in this case is the motor winding and output voltage ripple of the DC link capacitor 124. Additionally, utilizing traction inverter power module switches 122 achieves significant power device reduction. This configuration can be added to any existing e-drive platform design with the minimum modification. In addition, the dual bank 124 configuration achieves high power charging.

During this operating mode, i.e., third mode of operations M3, the output voltage of the electric vehicle supply equipment (EV SE) 200, i.e., the input 12, is boosted up to the HV battery voltage. In other words, the 400 V DC input 12 is boosted up to 800 V to charge the 800 V HV battery 140. This mode of operation also utilizes windings 112 of the motor 110 such that phase U of each motor 110 is connected in series with phases V and W to form two interleaved branches of the DC boost converter 180, which operates in continuous conduction mode (CCM) mode. The dual-bank configuration of the DC boost converter 180 provides redundancy and enables higher DC charging power. The Port 1 H-bridge that connects to the DC-link 124 of the TAB 130 is disconnected in the third mode of operation M3, and HV battery 140 (Ports 2) and the LV load 150 (Port 3) are galvanically connected through a Dual Active Bridge (DAB) 134 circuit. This allows the LV load 150 to be charged during the DC boost charging mode by the HV battery 140. As shown, only 4 switches 122 are being used due to the DC/DC topology.

Similar to the second mode of operation M2, the voltage of the HV battery 140 at the third port P3 is determined by the battery state-of-charge (SOC) which represents the percentage of charge remaining in the HV battery.

In some examples, an input EMI filter (not shown) may be electrically connected between the 800V DC input 12 and the motor 110. Additionally or alternatively, in some examples, an output EMI filter (not shown) may be electrically connected between the LV load 150, i.e., third port of the TAB 132c, 130 and the HV battery 140 i.e., second port of the TAB 132c, 130.

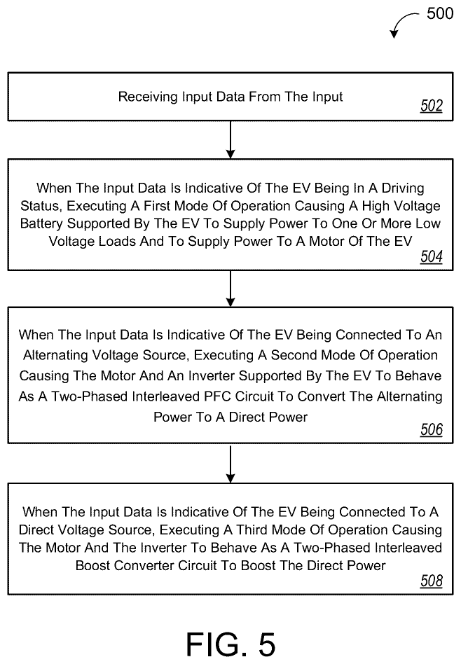

FIG. 5 provides an example arrangement of operations for a method 500 for operating the system described in FIGS. 1A-4B based on an input 12 received by the system 100. At block 502, the method 500 includes receiving input data from the input 12. In some examples, the input data includes at least one of a voltage sensor data, a current sensor data, and vehicle motion sensor data. When the input data is indicative of the EV 10 being in a driving status, the method 500 at block 504 includes executing a first mode of operation M1 causing a high voltage battery 140 supported by the EV 10 to supply power to one or more low voltage loads 150, 150a, 150b and to supply power to a motor 110, 110a, 110b of the EV 10. When the input data 12 is indicative of the EV 10 being connected to an alternating voltage source, the method 500 at block 506 includes executing a second mode of operation M2 causing the motor 110, 110a, 110b and an inverter 120, 120a, 120b supported by the EV 10 to behave as a two-phased interleaved PFC circuit 170, 170a, 170b to convert alternating power from the voltage source to direct power. Additionally, when the input data is indicative of the EV 10 being connected to a direct voltage source, such as a 400V DC, the method 500 at block 508 includes executing a third mode M3 of operation causing the motor 110, 110a, 110b and the inverter 120, 120a, 120b to behave as a two-phased interleaved boost converter circuit 180 to boost the direct power from the direct voltage source. The first, second, and third modes of operation (M1, M2, M3) are mutually exclusive.

In some examples, the two-phased interleaved boost converter circuit 180, 180a, 180b includes a first two-phased interleaved boost converter circuit 180a and a second two-phased interleaved boost converter circuit 180b to boost the direct voltage. The two-phased interleaved PFC circuit 170, 170a, 170b includes a first two-phased interleaved PFC circuit 170a and a second two-phased interleaved PFC circuit 170b.

In some examples, the first mode of operation causes the high voltage battery 140 to supply power to an additional motor 110b of the EV 10.

The system 100 and method 500 described provide highly integrated power electronics system for EVs. Different power electronics conversions inside the EV are integrated into one system 100 in one box to save costs and achieve volume reduction. Firstly, the most market adopted three phase Y-connected motor without the neutral terminal is used in the system 100, without any modification or specialization, such as Open Ended Winding Machine or Six-Phase Machine. The three-phase motor windings 112 are used in the system 100 for realizing the PFC coil for front end PFC converter of OBC and inductors for an interleaved boost converter for DC boost charging. Secondly, an integrated isolation transformer for DC-DC conversion is described with three ports, such that two secondary output ports were shown in the design for HV DC-DC conversion and for LV DC-DC conversion. Thirdly, dual bank architecture offers system redundancy.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, apparatus and/or device (e.g., magnetic discs, optical disks, memory, Programmable Logic Devices (PL Ds)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Implementations of the subject matter and the functional operations described in this specification can be implemented in digital electronic circuitry, or in computer software, firmware, or hardware, including the structures disclosed in this specification and their structural equivalents, or in combinations of one or more of them. Moreover, subject matter described in this specification can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The terms “data processing apparatus”, “computing device” and “computing processor” encompass all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

Similarly, while operations are depicted in the drawings in a particular order, this should not be understood as requiring that such operations be performed in the particular order shown or in sequential order, or that all illustrated operations be performed, to achieve desirable results. In certain circumstances, multi-tasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of implementations have been described. Nevertheless, it will be understood that various modifications may be made without departing from the spirit and scope of the disclosure. Accordingly, other implementations are within the scope of the following claims.

What is claimed is:

1. A method of operating a system based on an input to the system, the system being supported by an electric vehicle (EV), the method comprising:
receiving input data from the input;
when the input data is indicative of the EV being in a driving status, executing a first mode of operation causing a high voltage battery supported by the EV to supply power to one or more low voltage loads and to supply power to a motor of the EV; and
when the input data is indicative of the EV being connected to an alternating voltage source, executing a second mode of operation causing the motor and an inverter supported by the EV to behave as a two-phased interleaved PFC circuit to convert alternating power from the alternating voltage source to direct power.

2. The method of claim 1, further comprising when the input data is indicative of the EV being connected to a direct voltage source, executing a third mode of operation causing the motor and the inverter to behave as a two-phased interleaved boost converter circuit to boost direct power from the direct voltage source.

3. The method of claim 2, wherein the first, second, and third modes of operation are mutually exclusive.

4. The method of claim 2, wherein the two-phased interleaved boost converter circuit includes a first two-phased interleaved boost converter circuit and a second two-phased interleaved boost converter circuit.

5. The method of claim 1, wherein the two-phased interleaved PFC circuit includes a first two-phased interleaved PFC circuit and a second two-phased interleaved PFC circuit.

6. The method of claim 1, wherein the input data includes at least one of a voltage sensor data, a current sensor data, and vehicle motion sensor data.

7. The method of claim 1, wherein the first mode of operation causes the high voltage battery to supply power to an additional motor of the EV.

8. A system operating in three modes of operation based on an input to the system, the system supported by an electric vehicle, the system comprising:
data processing hardware; and
memory hardware in communication with the data processing hardware, the memory hardware storing instructions that when executed on the data processing hardware cause the data processing hardware to perform operations comprising:
receive input data from the input;
when the input data is indicative of the EV being in a driving status, execute a first mode of operation causing a high voltage battery supported by the EV to supply power to one or more low voltage loads and to supply power to a motor of the EV; and
when the input data is indicative of the EV being connected to an alternating voltage source, execute a second mode of operation causing the motor and an inverter supported by the EV to behave as a two-phased interleaved PFC circuit to convert alternating power from the alternating voltage source to direct power.

9. The system of claim 8, wherein the operations further comprise when the input data is indicative of the EV being connected to a direct voltage source, executing a third mode of operation causing the motor and the inverter to behave as a two-phased interleaved boost converter circuit to boost direct power from the direct voltage source.

10. The system of claim 9, wherein the first, second, and third modes of operation are mutually exclusive.

11. The system of claim 9, wherein the two-phased interleaved boost converter circuit includes a first two-phased interleaved boost converter circuit and a second two-phased interleaved boost converter circuit.

12. The system of claim 9, wherein the two-phased interleaved PFC circuit includes a first two-phased interleaved PFC circuit and a second two-phased interleaved PFC circuit.

13. The system of claim 8, wherein the input data includes at least one of a voltage sensor data, a current sensor data, and vehicle motion sensor data.

14. The system of claim 8, wherein the first mode of operation causes the high voltage battery to supply power to an additional motor of the EV.

15. A system operating in three modes of operation based on an input, the system supported by an electric vehicle, the system comprising:
an input receiving input data from one or more sensors;
a traction motor;
an inverter connected to the traction motor;
a DC-link capacitor connected to the inverter;
a high voltage battery;
a low voltage load; and
an isolated DC-DC Triple active bridge (TAB) having three bridges, a first bridge connected to the DC-link capacitor, a second bridge connected to the low voltage load, and a third bridge connected to the high voltage battery.

16. The system of claim 15, wherein when the input data is indicative of the EV being in a driving status, the high voltage battery supplies power to the low voltage load and to the traction motor.

17. The system of claim 15, wherein when the input data is indicative of the EV connected to an alternating voltage source, the traction motor and the inverter behave as a two-phased interleaved PFC circuit to convert alternating power from the alternating voltage source to direct power.

18. The system of claim 15, wherein when the input data is indicative of the EV connected to a direct voltage source, the traction motor and the inverter behave as a two-phased interleaved boost converter circuit to boost direct power from the direct voltage source.

19. The system of claim 15, wherein:
the traction motor includes a first traction motor and a second traction motor;
the inverter includes a first inverter and a second inverter;
the DC-link capacitor includes a first DC-link capacitor and a second DC-link capacitors; and
the isolated DC-DC Triple active bridge (TAB) includes a first isolated DC-DC TAB and a second isolated DC-DC TAB.

20. The system of claim 15, wherein the one or more sensors include voltage sensor, current sensors, and vehicle motion sensor.
